(19) United States
(12) Patent Application Publication
(10) Pub. No.: US 2015/0055958 A1
(43) Pub. Date: Feb. 26, 2015

(54) Remote Controller and Remote Controlling System

(71) Applicant: Chao-Yu Yueh, Taipei City (TW)

(72) Inventor: Chao-Yu Yueh, Taipei City (TW)

(21) Appl. No.: 14/460,639

(22) Filed: Aug. 15, 2014

(30) Foreign Application Priority Data
Aug. 23, 2013 (TW) 102130142

(51) Int. Cl. G08C 23/04

(52) U.S. Cl. CPC G08C 23/04
USPC 398/106

(57) ABSTRACT

A remote controller is adjacent to an electric device with an infrared (IR) signal receiving unit. The remote controller has a case, a signal receiving unit, a signal processing unit, and a signal radiating unit. The signal receiving unit, the signal processing unit, and the signal radiating unit are contained in the case. The signal receiving unit receives a wireless control signal through an access point (AP) from a mobile device. The signal processing unit converts the wireless control signal into an IR control signal. The signal radiating unit radiates the IR control signal to the IR signal receiving unit of the electric device.

### CROSS REFERENCE TO RELATED APPLICATIONS

This Non-provisional application claims priority under 35 U.S.C. §119(a) on Patent Application No. 102130142 filed in Republic of China on Aug. 23, 2013, the entire contents of which are hereby incorporated by reference.

### BACKGROUND

1. Technical Field

The disclosure relates to a remote controller, in particularly, to a remote controller and remote controlling system can be controlled by a smart mobile device through network.

2. Description of Related Art

Smartphones have become a popular device in the life since iPhone was introduced by Apple Inc., and smartphone is a growing trend in a few years. Many manufacturers have announced a variety of smart mobile devices such as smartphone and tablet. Smart mobile device has various functions such as entertainment, note, and internet. Therefore, technology application can be developed by mobile network technology.

Smart home appliance is one of the applications using the mobile network technology. The user can control home appliance anytime, anywhere through the network by smart mobile device, for example, the user can remote control to operate the air conditioner or television outside the house.

The current smart appliance must have a network connection function, whether it is television, washing machine, air conditioner, or freezer. In other words, the user must buy these appliances with network connection function so as to enjoy the convenience of smart appliance. However, the original home appliances in the absence of damage, the replacement is wasteful.

It is therefore an important subject of the invention to provide a remote controller and a remote controlling system.

### SUMMARY OF THE INVENTION

In view of the foregoing, the invention is to provide a remote controller and a remote controlling system.

To achieve the above, a remote controller is adjacent to an electric device with an infrared (IR) signal receiving unit. The remote controller has a case, a signal receiving unit, a signal processing unit, and a signal radiating unit. The signal receiving unit, the signal processing unit, and the signal radiating unit are contained in the case. The signal receiving unit receives a wireless control signal through an access point (AP) from a mobile device. The signal processing unit converts the wireless control signal into an IR control signal. The signal radiating unit radiates the IR control signal to the IR signal receiving unit of the electric device.

To achieve the above, a remote controlling system includes a mobile device, a terminal device, an electric device, and a remote controller. The mobile device delivers a remote control signal to a network. The terminal device generates a wireless control signal according to the remote control signal delivered from the network. The electric device has an infrared signal receiving unit. The remote controller has a case, a signal receiving unit, a signal processing unit, and a signal radiating unit. The signal receiving unit, the signal processing unit, and the signal radiating unit are contained in the case. The signal receiving unit receives a wireless control signal through an access point (AP) from a mobile device. The signal processing unit converts the wireless control signal into an IR control signal. The signal radiating unit radiates the IR control signal to the IR signal receiving unit of the electric device.

### BRIEF DESCRIPTION OF THE DRAWINGS

The parts in the drawings are not necessarily drawn to scale, the emphasis instead being placed upon clearly illustrating the principles of at least one embodiment. In the drawings, like reference numerals designate corresponding parts throughout the various diagrams, and all the diagrams are schematic.

FIG. 1 is a schematic diagram showing a circuit constriction of a remote controller according to one embodiment of the invention.

FIG. 2 is a schematic diagram showing an outward of the remote controller according to one embodiment of the invention.

FIG. 3 is a schematic diagram showing a remote controlling system according to one embodiment of the invention.

### DETAILED DESCRIPTION

Reference will now be made to the drawings to describe various inventive embodiments of the present disclosure in detail, wherein like numerals refer to like elements throughout.

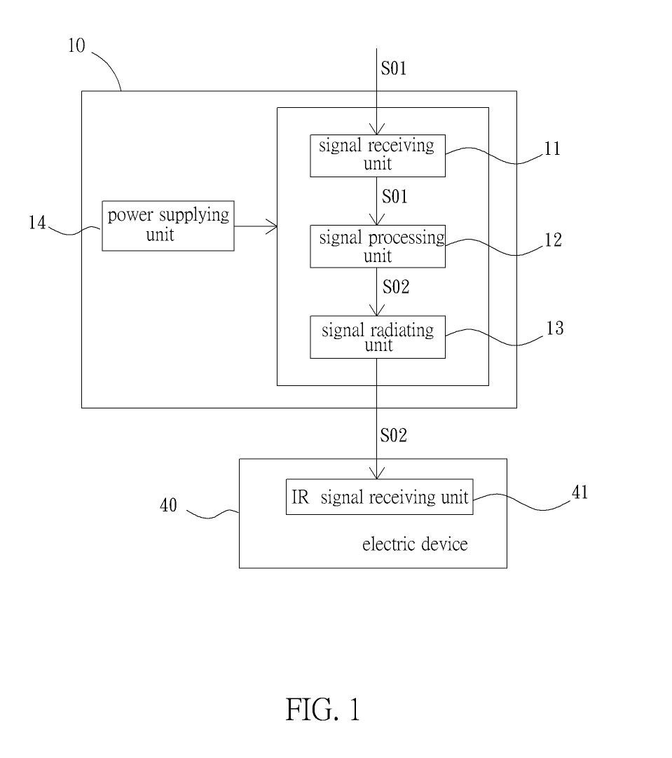

Referring to FIG. 1, which is a schematic diagram showing a remote controller 10. The remote controller 10 includes a signal receiving unit 11, a signal processing unit 12, a signal radiating unit 13, and a power supplying unit 14. In the embodiment, the remote controller 10 is adjacent to an electric device 40 with an infrared (IR) signal receiving unit 41 such as a television or an air conditioner.

The power supplying unit 14 outputs at least a power source to drive the signal receiving unit 11, the signal processing unit 12, and the signal radiating unit 13. The power supplying unit 14 may include an adaptor (AC/DC converter) and/or a DC/DC converter. In one embodiment, the power supplying unit 14 has the adaptor. The adaptor receives an AC power, and the AC power is converted into the power source (DC power) to output to the signal receiving unit 11, the signal processing unit 12, and the signal radiating unit 13. In another embodiment, the power supplying unit 14 has the DC/DC converter. The DC/DC converter receives a DC power output by a battery, and the DC power is converted in to the power source to output to the signal receiving unit 11, the signal processing unit 12, and the signal radiating unit 13.

The signal receiving unit 11 is utilized to receive at least one wireless control signal S01. The wireless control signal S01 is an IEEE 802.15 signal. In the embodiment, the IEEE 802.15 signal such as a Zigbee signal, a Bluetooth signal, or an Ultra wideband (UWB) signal.

The signal processing unit 12 converts the wireless control signal S01 into an infrared (IR) control signal S02. The wireless control signal S01 may be converted into the IR signal S02 by a signal mapping method via a lookup table or by an instant algorithm.

The signal radiating unit 13 radiates the IR control signal S02 to the IR signal receiving unit 41 of the electric device 40 to control the action of the electric device 40.

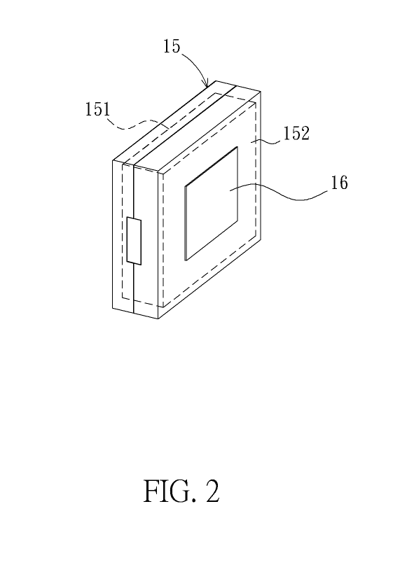

Referring to FIG. 1 and FIG. 2, a case 15 has a containing space 151. The signal receiving unit 11, the signal processing unit 12, the signal radiating unit 13, and the power supplying unit 14 are disposed in the containing space 151. The case 15 further has an opening, which is used to pass through the IR control signal S02 radiated from the signal radiating unit 13.

In the embodiment, an attaching unit 16 is attached to a surface 152 of the case 15. The case 15 is connected to the electric device 40 or an object needed to dispose by the attaching unit 16. The attaching unit 16 can be an engagement unit, an embedded unit, or an adhesive unit. In the embodiment, the attaching unit 16 may be a double-sided adhesive.

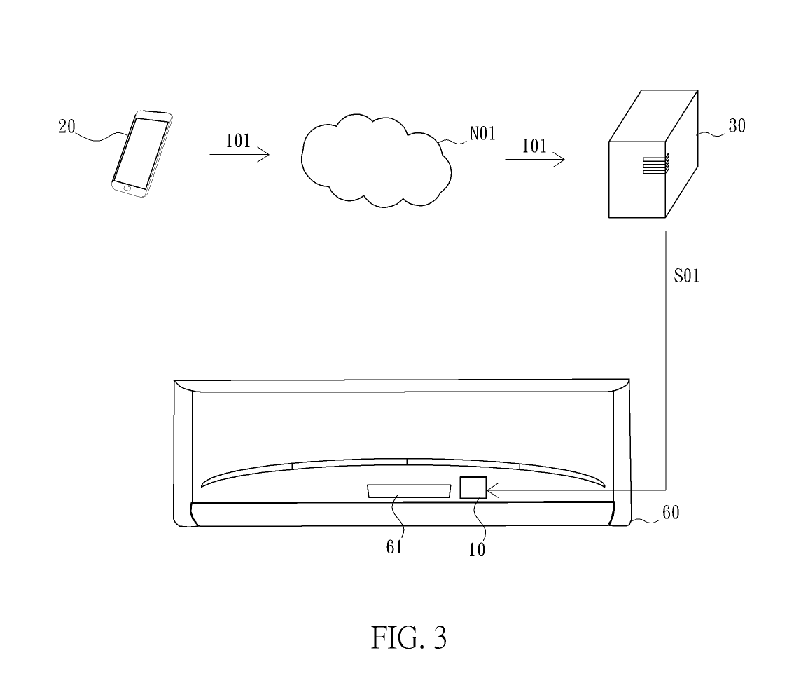

Referring to FIG. 3, which is a schematic diagram showing a remote controlling system. The remote controlling system includes a mobile device 20, a terminal device 30, an electric device 60, and a remote controller 10.

The mobile device 20 delivers a remote control signal I01 to a network N01. The terminal device 30 generates a wireless control signal S01 according to the remote control signal I01, which is delivered from the network N01. The electric device 60 has an infrared signal receiving unit 61. The remote controller 10 is described above. In the embodiment, the mobile device 20 may be a smart phone 20, the terminal device 30 at least has an access point, and the electric device 60 may be an air conditioner 60.

The remote controller 10 is disposed adjacent to the IR signal receiving unit 61 of the air conditioner 60 and electrically connected to the terminal device 30 by Zigbee technique. More description, the remote controller 10 is attached to a surface of the air conditioner 60 that adjacent to the IR signal receiving unit 61 by a double-sided adhesive 16.

In the embodiment, the user can control the air conditioner 60 through an application (App) installed in the smart phone 20. The smart phone 20 is connected to network N01, and a “turn on” instruction is chosen on the smart phone 20 by the user. The smart phone 20 delivers the remote control signal I01 to the network N01 in accordance with the instruction. Then, the remote control signal I01 is transmitted to the terminal device 30 through the network N01. The terminal device 30 generates the wireless control signal S01 after receiving the remote control signal I01, and the wireless control signal S01 is delivered to the remote controller 10. Finally, the remote controller 10 radiates the IR control signal to the IR signal receiving unit 61 of the air conditioner 60 to turn on the air conditioner 60.

As mentioned above, the user can control the home appliance outside the house through the network by the mobile device. Therefore, the smart appliance can be easily constructed by remote controller provided in the application.

Even though numerous characteristics and advantages of certain inventive embodiments have been set out in the foregoing description, together with details of the structures and functions of the embodiments, the disclosure is illustrative only. Changes may be made in detail, especially in matters of arrangement of parts, within the principles of the present disclosure to the full extent indicated by the broad general meaning of the terms in which the appended claims are expressed.

What is claimed is:

1. A remote controller adjacent to an electric device with an infrared signal receiving unit, comprising:
a case having a containing space;
a signal receiving unit, which is disposed in the containing space and receiving a wireless control signal;
a signal processing unit, which is disposed in the containing space, electrically connected to the signal receiving unit, and generating an infrared control signal in accordance with the wireless control unit; and
a signal radiating unit, which is disposed in the containing space, electrically connected to the signal processing unit, and radiating the infrared control signal to the infrared signal receiving unit of the electric device.

2. The remote controller of claim 1, further comprising:
a power supplying unit, which is outputting at least one power source to the signal receiving unit, the signal processing unit, and the signal radiating unit.

3. The remote controller of claim 1, wherein the wireless control signal is an IEEE 802.15 signal.

4. The remote controller of claim 3, wherein the wireless control signal is a Zigbee signal, a Bluetooth signal, or an Ultra wideband signal.

5. The remote controller of claim 1, further comprising an attaching unit, which is disposed on a surface of the case.

6. The remote controller of claim 5, wherein the attaching unit is a double-sided adhesive.

7. A remote controlling system, comprising:
a mobile device delivering a remote control signal to a network;
a terminal device, which generates a wireless control signal according to the remote control signal delivered from the network;
an electric device, which has an infrared signal receiving unit; and
a remote controller, comprising:
a case having a containing space;
a signal receiving unit, which is disposed in the containing space and receiving the wireless control signal from the terminal device;
a signal processing unit, which is disposed in the containing space, electrically connected to the signal receiving unit, and generating an infrared control signal in accordance with the wireless control unit; and
a signal radiating unit, which is disposed in the containing space, electrically connected to the signal processing unit, and radiating the infrared control signal to the infrared signal receiving unit of the electric device.

8. The remote controlling system of claim 7, further comprising:
a power supplying unit, which is outputting at least one power source to the signal receiving unit, the signal processing unit, and the signal radiating unit.

9. The remote controlling system of claim 7, wherein the wireless control signal is an IEEE 802.15 signal.

10. The remote controlling system of claim 9, wherein the wireless control signal is a Zigbee signal, a Bluetooth signal, or an Ultra wideband signal.

11. The remote controlling system of claim 7, further comprising an attaching unit, which is disposed on a surface of the case.

12. The remote controlling system of claim 11, wherein the attaching unit is a double-sided adhesive.
